(19) United States
(12) Patent Application Publication
(10) Pub. No.: US 2026/0200484 A1
(43) Pub. Date: Jul. 16, 2026

(54) AUTOMATED VALET PARKING SYSTEM AND AUTOMATED VALET PARKING METHOD

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP); Kazuhito ESHIMA, Toyota-shi (JP)

(73) Assignee: TOYOTA JIDOSHA KABUSHIKI KAISHA, Toyota-shi (JP)

(21) Appl. No.: 19/399,820

(22) Filed: Nov. 25, 2025

(30) Foreign Application Priority Data
Jan. 16, 2025 (JP) 2025-006038

(51) Int. Cl. B60W 50/029; B60W 30/06; B60W 50/02

(52) U.S. Cl. CPC B60W 50/029; B60W 30/06; B60W 50/0205; B60W 2050/0292; B60W 2552/15

(57) ABSTRACT

When a failure of a travel system of a vehicle is detected while traveling on a gradient road by AVP control, limp-home travel control is performed by an in-vehicle control device (computer). In the limp-home travel control, a limp-home travel path is set. The limp-home travel path includes a path point located on a gradient road and a path point located on a flat road connected to the gradient road, among path points included in a travel path for AVP control. In the limp-home travel control, the target position of the vehicle included in the path point located on the flat road among the path points included in the limp-home travel path is set as the target stop position of the vehicle. Then, the vehicle is controlled based on the limp-home travel path and the target stop position.

### CROSS-REFERENCE TO RELATED APPLICATION

This application claims priority to Japanese Patent Application No. 2025-006038 filed on January 16, 2025. The disclosure of the above-identified application, including the specification, drawings, and claims, is incorporated by reference herein in its entirety.

### BACKGROUND

### Technical Field

The present disclosure relates to automated valet parking (AVP) of vehicles in a predetermined area such as a parking lot.

### Description of Related Art

Japanese Unexamined Patent Application Publication No. 2022-41513 (JP 2022-41513 A) discloses a parking assistance device for a vehicle. The parking assistance device switches to parking assistance control in which electric power from an in-vehicle second power source is used when a defect occurs in an in-vehicle first power source. In the parking assistance control, when the gradient of a downward slope in a parking lot is large, the speed of the vehicle is made slower than when the gradient is not large.

### SUMMARY

It is assumed that a failure occurs in a travel system such as a battery, brakes, or power steering of a vehicle during AVP of the vehicle in a predetermined area and while traveling on a gradient road. When a failure occurs in the travel system, it is desirable to stop the travel of the vehicle promptly. However, when the vehicle is stopped in the middle of the gradient road, the vehicle may hinder AVP of other vehicles. Further, in AVP in which a vehicle is controlled based on a travel path generated by an external device of the vehicle, there is also an issue that it is difficult to stop the vehicle at a position deviating from the travel path.

The present disclosure can provide a technique of appropriately coping with a failure that occurs in a travel system of a vehicle during automated valet parking of the vehicle and while traveling on a gradient road.

A first aspect of the present disclosure provides a system that performs automated valet parking of a vehicle in a predetermined area. The system includes a management device and a control device. The management device manages the automated valet parking. The control device is mounted on the vehicle. The control device performs automated valet parking control of the vehicle based on a travel path received from the management device. The travel path includes a plurality of path points. Each of the path points includes information on a target position for the vehicle. When a failure of a travel system of the vehicle is detected while traveling on a gradient road through the automated valet parking control, the control device performs limp-home travel control of the vehicle. The limp-home travel control includes setting the travel path including a path point located on the gradient road and a path point located on a flat road connected to the gradient road as a limp-home travel path, setting the target position included in a path point included in the limp-home travel path and included in a path point located on the flat road as a target stop position for the vehicle, and controlling the vehicle based on the limp-home travel path and the target stop position.

A second aspect of the present disclosure provides a method of causing a computer to perform automated valet parking of a vehicle in a predetermined area. The method includes: performing automated valet parking control of the vehicle based on a travel path received from a management device that manages the automated valet parking; and when a failure of a travel system of the vehicle is detected while traveling on a gradient road through the automated valet parking control, performing limp-home travel control of the vehicle. The travel path includes a plurality of path points. Each of the path points includes information on a target position for the vehicle. When a failure of a travel system of the vehicle is detected while traveling on a gradient road through the automated valet parking control, the control device performs limp-home travel control of the vehicle. The limp-home travel control includes setting the travel path including a path point located on the gradient road and a path point located on a flat road connected to the gradient road as a limp-home travel path, setting the target position included in a path point included in the limp-home travel path and included in a path point located on the flat road as a target stop position for the vehicle, and controlling the vehicle based on the limp-home travel path and the target stop position.

According to the present disclosure, when a failure of a travel system of a vehicle is detected while traveling on a gradient road through automated valet parking control, limp-home travel control is performed by an in-vehicle control device (computer). In the limp-home travel control, a limp-home travel path is set. The limp-home travel path includes a path point located on a gradient road and a path point located on a flat road connected to the gradient road, among path points included in a travel path for automated valet parking control. In the limp-home travel control, the target position for the vehicle included in the path point located on the flat road, among the path points included in the limp-home travel path, is set as the target stop position for the vehicle. Then, the vehicle is controlled based on the limp-home travel path and the target stop position.

Therefore, even if a failure occurs in the travel system of the vehicle during automated valet parking of the vehicle and while traveling on the gradient road, the vehicle can perform limp-home travel to a target stop position on a flat road connected to the gradient road. This leads to suppressing the occurrence of a situation in which the vehicle continues to stay on the gradient road and hinders automated valet parking of other vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of an automated valet parking system;

FIG. 2 is a diagram illustrating a configuration example of a vehicle system;

FIG. 3 is a diagram illustrating an example of a travel path;

FIG. 4 is a diagram for explaining a first example of the limp-home travel control;

FIG. 5 is a diagram for explaining a second example of the limp-home travel control;

FIG. 6 is a diagram for explaining a third example of the limp-home travel control;

FIG. 7 is a diagram illustrating an example of a prohibited area set when the limp-home travel control is performed; and

FIG. 8 is a flowchart illustrating an example computer processing particularly related to features of an embodiment.

### DETAILED DESCRIPTION OF EMBODIMENTS

Hereinafter, embodiments of the present disclosure will be described with reference to the drawings. In the drawings, the same or corresponding parts are denoted by the same reference numerals, and description, simplification, or omission thereof is made.

### 1. Overall system configuration example

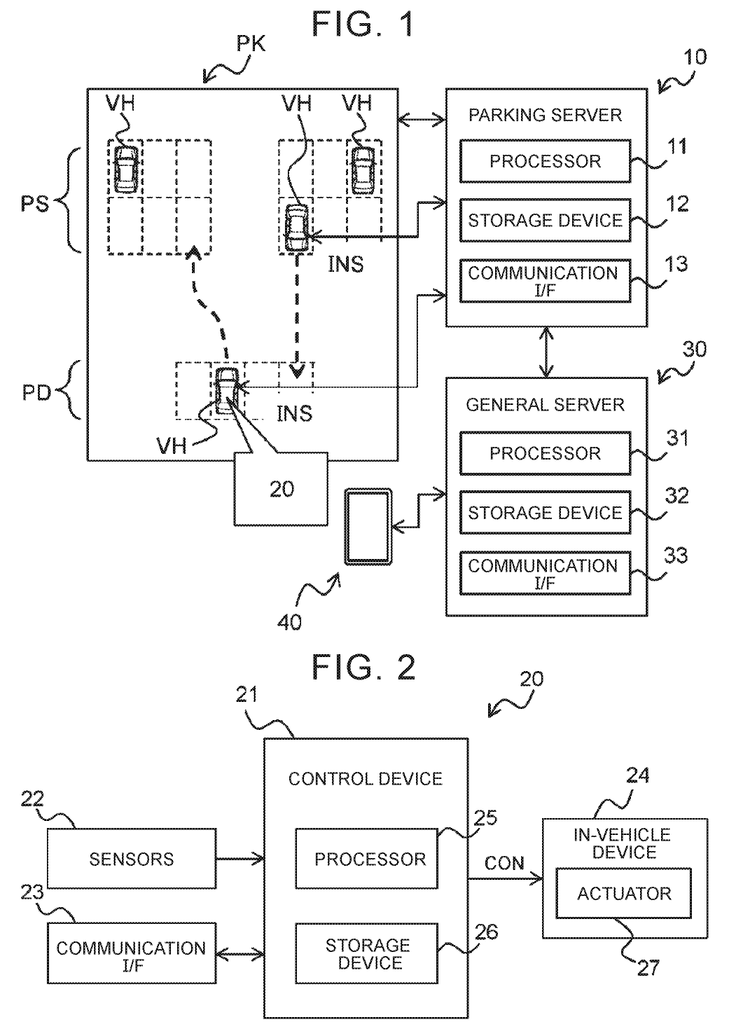

AVP system is a system that automatically performs a parking operation of vehicles in a predetermined area such as a parking lot, a factory, or a site of a facility. FIG. 1 is a diagram illustrating an exemplary configuration of an AVP device. FIG. 1 illustrates a parking lot PK as a predetermined area. The parking lot PK has a configuration capable of executing AVP. The configuration capable of executing AVP includes a getting-on/off space PD and a parking space PS.

The getting-on/off space PD is a space for getting off from the vehicle VH and/or getting on the vehicle VH. The parking space PS is a space for parking the vehicle VH. Configurations that can perform AVP also include markers that assist in moving vehicle VH within the parking lot PK, sensors that monitor vehicle VH (e.g., cameras, radars), and the like.

FIG. 1 also illustrates a server 10 that manages AVP in a parking lot PK (hereinafter, also referred to as a "parking lot server"). The parking lot servers 10 perform various processes related to managing the operating authority of the vehicle VH required for performing AVP missions (for example, parking entry missions, parking exit missions, and the like) in the parking lot PK. The parking lot servers 10 further acquire various types of information from the sensors of the parking lot PK, and perform various processes related to the execution of AVP missions based on the various types of information. The parking lot server 10 may be combined with a server (local server) that performs various processes related to the execution of AVP mission and a server (cloud server) that performs various processes related to the administration of AVP.

The parking lot server 10 is typically a computer including at least one processor 11, at least one storage device 12, and a communication I/F (interface) 13. The processor 11 executes various processes. Examples of the processor 11 include CPU (Central Processing Unit), GPU (Graphics Processing Unit), ASIC (Application Specific Integrated Circuit), FPGA (Field-Programmable Gate Array), and the like. The processor 11 may also be referred to as "circuitry" or "processing circuitry." A "circuitry" is hardware that is programmed to implement the described functions or hardware that performs the functions. The processor 11 reads various kinds of information from the storage device 12 and stores various kinds of information in the storage device 12.

Examples of the storage device 12 include volatile memory, non-volatile memory, HDD (Hard Disk Drive), SSD (Solid State Drive), and the like. Examples of the various types of information stored in the storage device 12 include parking lot map information, parking lot use information, and vehicle management information. The parking lot map information indicates map information of the parking lot PK. The parking lot use information is information related to the getting-on/off space PD in the parking lot PK and the use status (free information) of the parking space PS. The vehicle control information includes information such as a vehicle ID, an entry/exit history, and a vehicle position history. The vehicle management information is managed for each vehicle VH. The vehicle ID is the identity of the vehicle VH. The entry/exit history is information related to a history of entry/exit of the vehicle VH (for example, an appointment date, an appointment time, an actual date, an actual time, and the like). The vehicle position history indicates the history of the position of the vehicle VH in the parking lot PK.

The communication I/F 13 is an interface for communicating with an external device of the parking lot server 10 to transmit and receive data. For example, the communication I/F 13 includes a device for connecting to a surrounding device via a radio LAN, a device for connecting to a mobile communication network, a device for connecting to the Internet, and the like. The parking lot server 10 transmits and receives data to and from a vehicle VH (vehicle system 20) via a communication I/F 13. The parking lot server 10 also transmits and receives data to and from the overall server 30 via a communication I/F 13.

FIG. 2 is a diagram illustrating a configuration example of the vehicle system 20. In the embodiment illustrated in FIG. 2, the vehicle system 20 is mounted on each of the vehicle VH as a system capable of executing AVP. In the embodiment illustrated in FIG. 2, the vehicle system 20 includes a control device 21, sensors 22, a communication I/F 23, and an in-vehicle device 24.

The control device 21 is communicably connected to the sensors 22, the communication I/F 23, and the in-vehicle device 24. The control device 21 is a computer that performs information processing related to control of the vehicle VH based on various types of information. The control device 21 includes at least one processor 25 and at least one storage device 26. The configuration example of the processor 25 is the same as that of the processor 11 shown in FIG. 1. The configuration example of the storage device 26 is the same as that of the storage device 12 illustrated in FIG. 1. The processor 25 realizes information processing related to the control of the vehicle VH in cooperation with the storage device 26.

For example, the control device 21 is configured by one or a plurality of ECU (Electronic Control Unit). In another embodiment, the control device 21 comprises a kit (e.g., an AVP kit) for the functions provided by the parking lot servers 10. The control device 21 generates and outputs a control signal of the vehicle VH by information processing. When the vehicle VH receives AVP mission instruction INS from the parking lot server 10, the control device 21 generates a control signal CON for AVP mission. The control signal CON is transmitted to the in-vehicle device 24.

The sensors 22 detect environmental conditions and driving conditions of the vehicle VH. Examples of the sensors 22 include cameras, radars, LiDAR, wheel speed sensors, IMU (Inertial Measurement Unit), GNSS (Global Navigation Satellite System) sensors, and the like. The sensors 22 also include sensors that monitor the state of the in-vehicle device 24 and the state of the in-vehicle battery.

The communication I/F 23 is an interface for communicating with a device outside the vehicle VH to transmit and receive data. The vehicle VH transmits and receives data to and from the parking lot servers 10 via the communication I/F 23. The vehicle VH can also transmit and receive data to and from the user terminal 40 via a communication I/F 23.

The in-vehicle device 24 includes lighting devices, onboard lighting devices, horns, wipers, doors, door windows, mirrors, drives, brakes, steering devices, HMI (Human Machine Interface), and the like. Each device of the in-vehicle device 24 includes an actuator 27 controllable by the control device 21. The in-vehicle device 24 acquires a control signal from the control device 21. The actuator 27 operates in accordance with the control signal, so that the control device 21 controls the in-vehicle device 24. In addition, control of the vehicle VH is realized by control of the in-vehicle device 24. Vehicle control for AVP mission is realized by the actuator 27 operating in accordance with the control signal CON for AVP mission.

Returning to FIG. 1, a description of an overall configuration example will be continued. FIG. 1 also depicts an overall server 30. The overall server 30 is a server (cloud server) that manages the entire AVP service. The overall server 30 may have some or all of the functions of the parking lot server 10. The overall server 30 manages a user who uses AVP service (hereinafter, also referred to as "AVP user"), a vehicle having the vehicle system 20 (that is, a vehicle VH), and the like. Drivers of the vehicle VH are exemplary AVP users. The management of AVP user includes the authentication of AVP user, the management of AVP reservation by AVP user, and the like. The management of the vehicle VH includes management of the vehicle information of the vehicle VH, management of the operation authority of the vehicle VH, management of AVP operation log of the vehicle VH, and the like.

The overall servers 30 are typically computers that include at least one processor 31, at least one storage device 32, and a communication I/F 33. The configuration example of the processor 31 is the same as that of the processor 11. The configuration example of the storage device 32 is the same as that of the storage device 12.

Examples of the various types of information stored in the storage device 32 include AVP reservation information, user information, and AVP vehicle information. AVP reservation information is information related to the reservation of AVP by AVP user. AVP reservation information includes information such as a parking lot and a storage and retrieval time that AVP user desires to use. The user information includes information such as a vehicle ID of a vehicle used by a user ID, AVP user of AVP user. The user data is managed for AVP user. AVP vehicle information includes information such as the vehicle ID of the vehicle having the vehicle system 20, IP address of the vehicle system 20, and AVP operation log of the vehicle system 20.

The communication I/F 33 is an interface for communicating with an external device of the overall server 30 to transmit and receive data. For example, the communication I/F 33 includes a device for connecting to a surrounding device via a radio LAN, a device for connecting to a mobile communication network, a device for connecting to the Internet, and the like. The overall server 30 transmits and receives data to and from the parking lot server 10 via a communication I/F 33. The overall servers 30 also transmit and receive data to and from the user terminals 40 via a communication I/F 33.

The user terminal 40 is, for example, a terminal carried by an AVP user (for example, a tablet/smart phone). AVP user transmits and receives data to and from the vehicle VH (vehicle system 20) by operating the user terminal 40. AVP user also transmits and receives data to and from the overall servers 30 by operating the user terminals 40. The user terminal 40 is used for registering or reserving the use of AVP service by AVP user. The user terminal 40 is also appropriately used for AVP in the parking lot PK. Instead of the operation of the user terminal 40, the information regarding AVP may be transmitted and received by the operation of the in-vehicle device 24 (for example, HMI) illustrated in FIG. 2.

### 2. Travel Path and Plan

When executing AVP mission (parking entry mission), for example, the parking lot server 10 transmits and receives information to and from the overall server 30, and acquires the operating authority of the vehicle VH waiting in the getting-on/off space PD. When the operating authority is transferred to the parking lot server 10, the parking lot server 10 (the processor 11) can execute AVP of the vehicle VH. The vehicle system 20 (processor 25) may generate a control signal CON in accordance with an instruction INS of a AVP mission (parking entry mission) received from the parking lot server 10, and control the in-vehicle device 24. Thus, the vehicle control (AVP control) for AVP mission (parking entry mission) is performed.

When implementing AVP mission (parking exit mission), for example, the vehicle system 20 (processor 25) may generate a control signal CON in accordance with instruction INS of AVP mission (parking exit mission) received from the parking lot server 10, and control the in-vehicle device 24. Thus, the vehicle control (AVP control) for AVP mission (parking exit mission) is performed. When the vehicle VH arrives at the getting-on/off space PD, the parking lot server 10 transmits and receives information to and from the overall server 30 and returns the right to operate the vehicle VH. By transferring the operating authority to the overall server 30, the parking lot server 10 (processor 11) finishes executing AVP mission (parking exit mission) of the vehicle VH.

The instruction INS of AVP mission includes the travel path PT. The travel path PT is a set of path points PP in the parking lot PK through which the vehicle VH should pass from the current position of the vehicle VH to the destination. The instruction INS is sequentially generated on the basis of environmental conditions and driving conditions of the vehicle VH acquired from the sensors of the parking lot PK. The data acquired from the sensors 22 of the vehicle VH may be used to generate the instruction INS. The generated instruction INS is sequentially transmitted from the parking lot servers 10 to the vehicle VH. The instruction INS transmitted at the respective timings includes the travel path PT in the traveling direction of the vehicle VH.

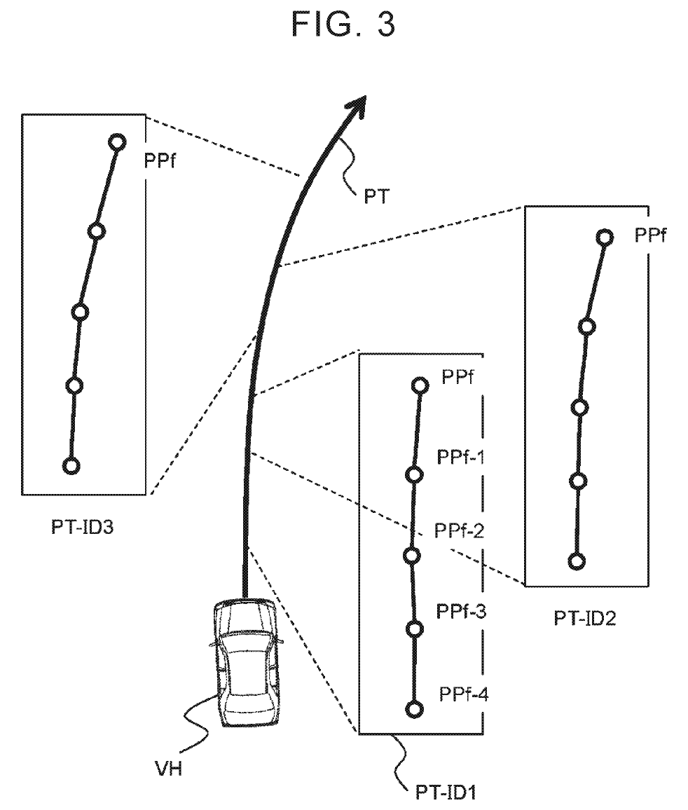

FIG. 3 is a diagram illustrating an exemplary travel path PT. In FIG. 3, a travel path PT is depicted in front of the vehicle VH. The travel path PT includes a section path PT-ID1, a section path PT-ID2, and a section path PT-ID3. The section paths PT-ID1, PT-ID2 and PT-ID3 are included in instruction INS sequentially received by the vehicle VH (vehicle system 20) during AVP mission. The interval paths PT-ID1, PT-ID2 and PT-ID3 are identified by unique ID assigned to each interval path PT-IDk (k ≥ 1).

The section path PT-IDk includes a path point PP indicating an end point of the section path PT-IDk (hereinafter, also referred to as "path end point PPf"). In the embodiment illustrated in FIG. 3, the section path PT-ID1 includes a path end point PPf, a path point PPf-1 before the path end point PPf, a path point PPf-2, a path point PPf-3, and a path point PPf-4. The path point PPf-4 can also be considered as a path point PP indicating the start point of the section path PT-ID1. The configuration of the section path PT-ID2 and the path point PP of PT-ID3 is basically the same as the configuration of the path point PP of the section path PT-ID1.

The path points PP included in the section path PT-IDk include, for example, position information, steering angle information, maximum speed information, and curvature information. The position information indicates a target position of the vehicle VH, and is represented by a two-dimensional coordinate system (x, y) of the parking lot PK. The position data may be represented by a three-dimensional coordinate system (x, y, z) including a height. The steering angle data indicates a target steering angle of the vehicle VH in the path point PP. The maximum speed data indicates an allowable maximum speed of the vehicle VH at the path point PP. The curvature data indicates the curvature of the section path PT-IDk.

The vehicle system 20 sets a travel plan for following the section path PT-IDk on the basis of information included in the respective path points PP of the section path PT-IDk and information on the surroundings and travel conditions of the vehicle VH. The set travel plan includes a speed plan and a steering angle plan. The vehicle system 20 also performs vehicle control (AVP control) in accordance with the set travel plan. Specifically, the vehicle system 20 calculates a deviation between the vehicle VH and the travel plan (e.g., a velocity deviation, a lateral position deviation, and a yaw angle deviation), generates a control target such that the deviation is reduced, and transmits a control signal CON to the actuator 27. The control target value is, for example, a target acceleration or a target steering angle. The actuator 27 is, for example, a drive actuator, a braking actuator, or a steering actuator. Accordingly, AVP operation is performed along the travel path PT.

### 3. Features of the embodiments

### 3-1. Issues during gradient road travel

As described above, in AVP mission, the travel path PT is used to perform AVP control of the vehicle VH. Here, depending on the configuration of the parking lot PK, the passage of the parking lot PK may include a gradient road in addition to the flat road. Examples of the slope (inclination angle) of the gradient road include a gradual slope (for example, 3% or less), a normal slope (for example, 3 to 6%), and a steep slope (for example, 6% or more). In the embodiment, in particular, the case where the gradient road is a normal path or a steep path is considered.

In the embodiment, it is also considered that a failure occurs in a travel system such as a battery, a brake, or a power steering of a vehicle VH while traveling on a gradient road due to a vehicle VH in a AVP mission. When a failure occurs in the travel system, it is desirable that the traveling of VH of vehicles is stopped promptly. However, if the vehicle VH is stopped in the middle of the gradient road, the vehicle VH may hinder AVP missions of other vehicles. Further, there is also a problem that it is difficult to stop the vehicle VH at a position deviating from the travel path PT in AVP where the vehicle VH is controlled based on the travel path PT generated by the parking lot server 10.

### 3-2. Limp-home travel control

Therefore, in the embodiment, when a failure occurs in the travel system of the vehicle VH while traveling on the gradient road, the vehicle system 20 performs the "limp-home travel control". In the limp-home travel control, the limp-home travel path PTR is generated based on the section path PT-IDk. Examples of the section path PT-IDk used for generating the limp-home travel path PTR include those received by the vehicle system 20 from the parking lot servers 10 before and after the timings at which the failure of the travel system is detected. For example, the section path PT-IDk received by the vehicle system 20 immediately before or immediately after the failure is detected is suitably used to generate the limp-home travel path PTR. Two or more consecutive section paths (for example, section paths PT-IDk-1 and PT-IDk, section paths PT-IDk and PT-IDk+1) may be used to generate the limp-home travel path PTR.

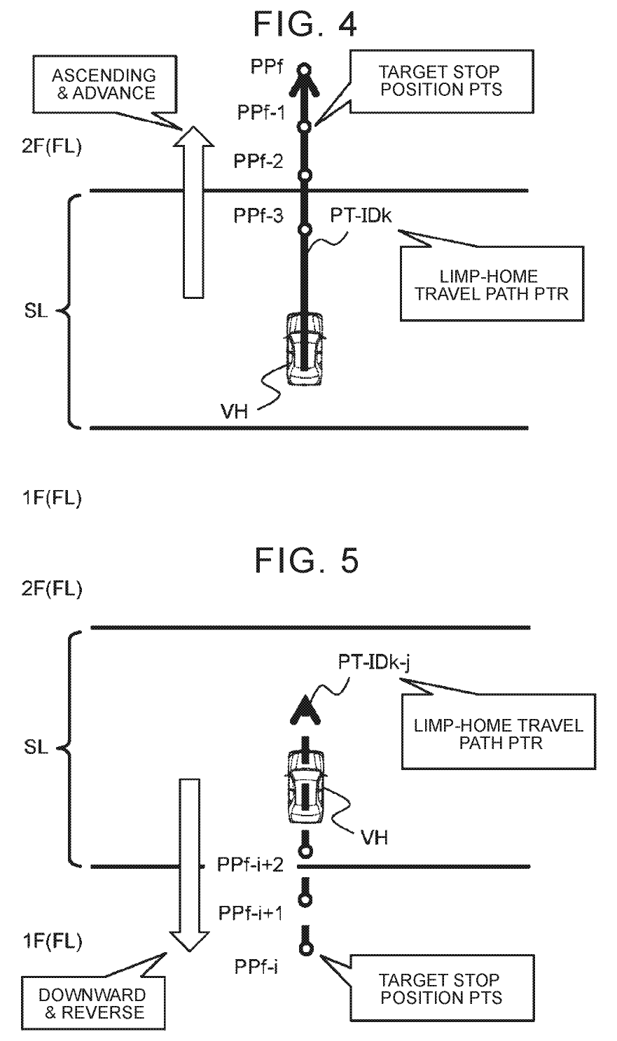

FIG. 4 is a diagram illustrating a first example of the limp-home travel control. A gradient road SL is depicted in FIG. 4. The gradient road SL is a passage connecting between the flat road FL of the first floor (1F) and the flat road FL of the second floor (2F) of the facilities in the parking lot PK. FIG. 4 also illustrates a vehicle VH from the first floor to the second floor on the gradient road SL.

In the embodiment illustrated in FIG. 4, it is assumed that a failure in the travel system of the vehicle VH is detected during traveling of the gradient road SL. Under this assumption, in the limp-home travel control, the limp-home travel path PTR is set using the section path PT-IDk. The section path PT-IDk illustrated in FIG. 4 is, for example, the latest one received by the vehicle system 20 immediately before the timing at which the failure of the travel system is detected. The section path PT-IDk includes a path end point PPf, a path point PPf-1, a path point PPf-2, a path point PPf-3. The setting of the limp-home travel path PTR is performed, for example, as follows. First, a path point PP located in the flat road FL is specified from among the path points PP included in the section path PT-IDk (in the example of FIG. 4, the path end point PPf, the path point PPf-1, and PPf-2).

The path point PP located in the flat road FL is specified based on, for example, position information (height information) included in the path point PP. For example, when the height data of two adjacent path points PP coincide with each other, it is determined that the path points PP are located in the flat road FL. When the path point PP located on the flat road FL is identified, the section path PT-IDk including the path point PP is set as the limp-home travel path PTR.

Subsequently, from among the path points PP included in the limp-home travel path PTR, the path point PP located on the flat road FL is set to the target stop position PTS. The target stop position PTS is a target position at which the vehicle VH should stop in the limp-home travel control. Therefore, the path point PP set to the target stop position PTS does not have to coincide with the path end point PPf of the section path PT-IDk set as the limp-home travel path PTR (in the example of FIG. 4, the path point PPf-1).

When the target stop position PTS is set, a travel plan for following the limp-home travel path PTR and stopping at the target stop position PTS is set on the basis of the limp-home travel path PTR and the target stop position PTS and information on the surrounding environment and the travel state of the vehicle VH. The set travel plan includes a speed plan and a steering angle plan. In the limp-home travel control, VH of vehicles is controlled in accordance with the set travel plan. The control method of the vehicle VH according to the travel plan is basically the same as AVP control according to the travel plan in AVP mission.

That is, in the limp-home travel control, a deviation (for example, a velocity deviation, a lateral position deviation, and a yaw angle deviation) between the vehicle VH and the travel plan is calculated, and a control target value (for example, a target acceleration and a target steering angle) is generated such that the deviation is reduced. Then, a control signal corresponding to the control target value is transmitted to the actuator 27, whereby the limp-home travel along the limp-home travel path PTR and the target stop position PTS is performed.

FIG. 5 is a diagram for explaining a second example of the limp-home travel control. The situation surrounding the vehicle VH shown in FIG. 5 is the same as that described with reference to FIG. 4. The section path PT-IDk-j (j ≥ 1) illustrated in FIG. 5 is, for example, a past received by the vehicle system 20 prior to the timing at which the failure of the travel system is detected. The interval path PT-IDk-j includes path points PPf-i, PPf-i+1, PPf-i+2 (i ≥ 3). The path point PPf-i is a path point PP (hereinafter, also referred to as "path start point PPf-i") indicating the start point of the section path PT-IDk.

The method of setting the limp-home travel path PTR is the same as that of the embodiment described with reference to FIG. 4. That is, first, a path point PP located in the flat road FL is specified from among the path points PP included in the section path PT-IDk-j (in the example of FIG. 5, the path start point PPf-i and the path point PPf-i+1). When the path point located on the flat road FL is identified, the section path PT-IDk-j including the path point is set as the limp-home travel path PTR. Subsequently, from among the path points PP included in the limp-home travel path PTR, the path point PP located on the flat road FL is set to the target stop position PTS. The method of setting the target stop position PTS is also the same as that of the example illustrated in FIG. 4 (in the example illustrated in FIG. 5, the path start point PPf-i).

When the target stop position PTS is set, a travel plan for following the limp-home travel path PTR and stopping at the target stop position PTS is set on the basis of the limp-home travel path PTR and the target stop position PTS and information on the surrounding environment and the travel state of the vehicle VH. The control method of the vehicle VH according to the set travel plan is the same as that of the embodiment described with reference to FIG. 4.

The difference between the first example described in FIG. 4 and the second example described in FIG. 5 is the difference between the section path PT-IDk and the section path PT-IDk-j used for setting the limp-home travel path PTR. Therefore, in the former, the forward movement in the direction up the gradient road SL is performed as the limp-home travel, whereas in the latter, the backward movement in the direction down the gradient road SL is performed as the limp-home travel.

For example, in a case where the gradient road SL is long, in a case where the present position of the vehicle VH is located at the start point of the gradient road SL, or the like, a case where the path point PP located on the flat road FL cannot be specified in front of the vehicle VH is assumed. When the backup power is insufficient in the event of a battery failure (power supply failure), even if the path point PP located on the flat road FL can be specified in front of the vehicle VH, the vehicle VH may not climb up the gradient road SL. In such a case, the example described in FIG. 5 is useful. That is, the path point PP located in the flat road FL behind the vehicle VH is specified by using the section path PT-IDk received by the vehicle system 20 prior to the timing at which the failure of the travel system is detected. According to the embodiment of FIG. 5 in which the backward movement down the gradient road SL is performed, the vehicle VH can reliably perform limp-home travel to the target stop position PTS on the flat road FL connected to the gradient road SL.

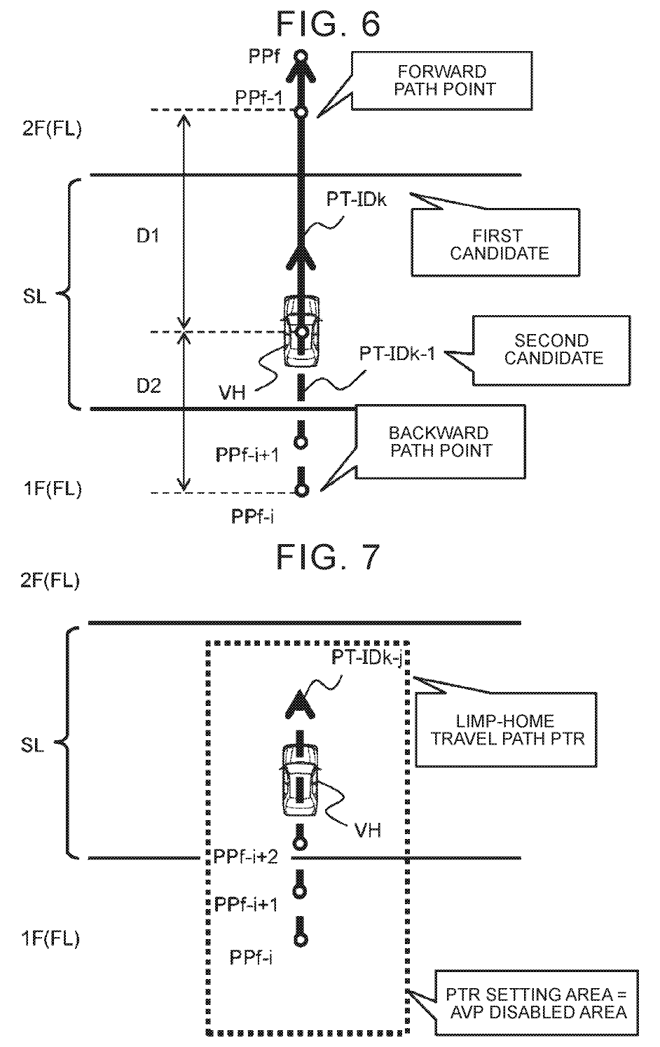

When the path point PP located on the flat road FL can be specified in the front and rear of the vehicle VH and does not apply to the exceptional condition such as the shortage of the backup power as described above, the following limp-home travel control can be performed. FIG. 6 is a diagram for explaining a third example of the limp-home travel control. The situation surrounding the vehicle VH shown in FIG. 6 is the same as that described with reference to FIG. 4. In the embodiment illustrated in FIG. 6, a section path PT-IDk including a path point PP (hereinafter, also referred to as "front path point PP") located in a flat road FL in front of the vehicle VH and a path point PT-IDk-j including a path point PP (hereinafter, also referred to as "rear path point PP") located in a flat road FL behind the vehicle VH is specified.

For convenience of explanation, the section path PT-IDk shown in FIG. 6 is the same as that described in FIG. 4, and the section path PT-IDk-j shown in FIG. 6 is the same as that described in FIG. 5. In the embodiment illustrated in FIG. 6, the section paths PT-IDk and PT-IDk-j are regarded as the first and second candidates of the limp-home travel path PTR, respectively, and the limp-home travel path PTR is set by comparing the first and second candidates. For example, the distance (rearward distance) D2 from the current position of the vehicle VH to the target position of the front path point PP (PPf-1 in the example of FIG. 6) and the distance (rearward distance) D1 from the current position to the target position of the rear path point PP (PPf-i in the example of FIG. 6) are compared.

As a result of comparing the distance D1 and the distance D2, candidates having a shorter distance are set as the limp-home travel path PTR (in the example of FIG. 6, the section path PT-IDk-j). An example of the limp-home travel control after the limp-home travel path PTR is set is the same as the example described with reference to FIGS. 4 or 5.

### 3-3. Establishment of prohibited areas

When the limp-home travel control is performed, the vehicle system 20 transmits a signal indicating that a failure has occurred in the travel system to the parking lot server 10. In addition, the vehicle system 20 transmits the limp-home travel path PTR to the parking lot server 10. The parking lot server 10 that received a signal indicating that a failure occurred in the travel system detects a failure in the travel system of the vehicle VH. Alternatively, the parking lot servers 10 detect a failure in the travel system of the vehicle VH by receiving the limp-home travel path PTR.

The parking lot server 10 that has detected the failure of the travel system of the vehicle VH may set the prohibited area of AVP mission based on the limp-home travel path PTR received from the vehicle system 20. When a prohibited area of AVP mission is set, AVP mission of the other vehicle VH is performed so as to avoid the prohibited area. Therefore, it is possible to prevent the vehicle VH stopping at the target stop position PTS from being prevented from performing AVP missions of the other vehicle VH.

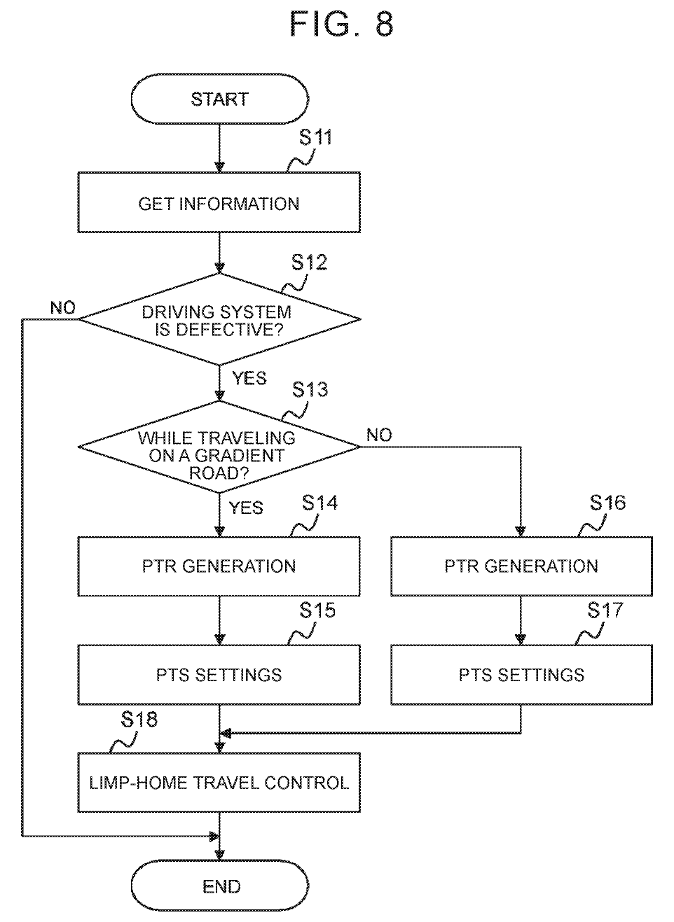

FIG. 7 is a diagram illustrating an exemplary prohibited area of AVP mission set when the limp-home travel control is performed. The limp-home travel path PTR shown in FIG. 7 is the same as the section path PT-IDk-j shown in FIG. 5. The prohibited area of AVP mission is set in the setting area of the limp-home travel path PTR. The setting area of the limp-home travel path PTR has, for example, a vertical width including all the path points PP included in the limp-home travel path PTR and a horizontal width equal to or larger than the vehicle width of the vehicle VH and equal to or smaller than the passage width.

### 3-4. Computer Processing Example

FIG. 8 is a flowchart illustrating an example computer processing particularly related to features of an embodiment. The routine illustrated in FIG. 8 is executed by the control device 21 (processor 25) illustrated in FIG. 2. The routine illustrated in FIG. 8 is repeatedly executed at a predetermined cycle during AVP mission, for example.

In the embodiment illustrated in FIG. 8, first, in S11 process, various types of information of the vehicle VH are acquired. The various types of information acquired by S11 include instruction INS (travel path PT) transmitted from the parking lot servers 10, information acquired by the sensors 22 of the vehicle VH, and signals from the in-vehicle devices 24.

Following S11 process, S12 process is performed. In S12 process, it is determined whether or not a failure of the travel system of the vehicle VH is detected based on various pieces of information acquired by S11. If S12 determination is positive, S13 process is performed. Otherwise, the current routine ends.

In S13 process, it is determined whether or not the vehicle VH is traveling on a gradient road. The slope of the passage through which the vehicle VH travels is calculated, for example, based on the detected data of IMU. For example, when the slope of the passage is 3% or more, it is determined that the vehicle VH is traveling on the gradient road. If S13 determination is positive, S14 process is performed. Otherwise, S16 process is performed.

In S14 and S16 processes, the limp-home travel path PTR is set. However, the method of setting the limp-home travel path PTR set in S14 process differs from that of the limp-home travel path PTR set in S16 process. That is, the first setting method includes a process of specifying the path point PP located in the flat road FL from among the path points PP included in the section path PT-IDk. On the other hand, in the latter setting method, the latest section path PT-IDk received by the vehicle system 20 immediately before the timing at which the failure of the travel system is detected is set to the limp-home travel path PTR as it is. When there are two candidates for the limp-home travel path PTR in S14 process, one of these candidates may be selected.

S14 process is followed by S15 process. In S15 process, from among the path points PP included in the limp-home travel path PTR set by S14, the path point PP located on the flat road FL is set to the target stop position PTS.

S16 process is followed by S17 process. The processing of S17 is basically the same as the processing of S15. That is, in S17 process, from among the path points PP included in the limp-home travel path PTR set by S16, the path point PP located on the flat road FL is set to the target stop position PTS.

Processing of S15 or S17 is followed by processing of S18. In S18 process, the traveling plan is set based on information set by S14 and S15 (or information set by S16 and S17) and information on the surrounding environment and the traveling condition of the vehicle VH. This traveling plan is a traveling plan for following the limp-home travel path PTR and stopping at the target stop position PTS. Then, VH of vehicles is controlled in accordance with the travel plan.

What is claimed is:

1. An automated valet parking system that performs automated valet parking of a vehicle in a predetermined area, comprising:
a management device that manages the automated valet parking; and
a control device that is mounted on the vehicle and performs automated valet parking control of the vehicle based on a travel path received from the management device, wherein:
the travel path includes a plurality of path points;
each of the path points includes information on a target position for the vehicle;
when a failure of a travel system of the vehicle is detected while traveling on a gradient road through the automated valet parking control, the control device performs limp-home travel control of the vehicle; and
the limp-home travel control includes
setting the travel path including a path point located on the gradient road and a path point located on a flat road connected to the gradient road as a limp-home travel path,
setting the target position included in a path point included in the limp-home travel path and included in a path point located on the flat road as a target stop position for the vehicle, and
controlling the vehicle based on the limp-home travel path and the target stop position.

2. The automated valet parking system according to claim 1, wherein:
when a travel path including a forward path point located on a flat road ahead of the vehicle is set as the limp-home travel path in the setting of the limp-home travel path, the controlling of the vehicle based on the target stop position and the limp-home travel path is performed through forward movement of the vehicle; and
when a travel path including a rearward path point located on a flat road behind the vehicle is set as the limp-home travel path in the setting of the limp-home travel path, the controlling of the vehicle based on the target stop position and the limp-home travel path is performed through rearward movement of the vehicle.

3. The automated valet parking system according to claim 1, wherein:
when candidates for the limp-home travel path include a first candidate including a forward path point located on a flat road ahead of the vehicle and a second candidate including a rearward path point located on a flat road behind the vehicle in the setting of the limp-home travel path, a forward distance from a current position to a target position included in the forward path point and a rearward distance from the current position to a target position included in the rearward path point are calculated; and
the first candidate is set as the limp-home travel path when the forward distance is shorter than the rearward distance, and the second candidate is set as the limp-home travel path when the rearward distance is shorter than the forward distance.

4. The automated valet parking system according to claim 1, wherein when a failure of the travel system of the vehicle is detected while the vehicle is traveling on a gradient road, the management device sets a setting area of the limp-home travel path as a prohibition area of automated valet parking for other vehicles based on the limp-home travel path received from the control device.

5. An automated valet parking method of causing a computer to perform automated valet parking of a vehicle in a predetermined area, comprising:
performing automated valet parking control of the vehicle based on a travel path received from a management device that manages the automated valet parking; and
when a failure of a travel system of the vehicle is detected while traveling on a gradient road through the automated valet parking control, performing limp-home travel control of the vehicle, wherein:
the travel path includes a plurality of path points;
each of the path points includes information on a target position for the vehicle; and
the limp-home travel control includes
setting the travel path including a path point located on the gradient road and a path point located on a flat road connected to the gradient road as a limp-home travel path,
setting the target position included in a path point included in the limp-home travel path and included in a path point located on the flat road as a target stop position for the vehicle, and
controlling the vehicle based on the limp-home travel path and the target stop position.
